(19) United States
(12) Patent Application Publication
(10) Pub. No.: US 2026/0001587 A1
(43) Pub. Date: Jan. 1, 2026

(54) VEHICLE STEERING RACK ASSEMBLY

(71) Applicant: NISSAN NORTH AMERICA, INC., Franklin, TN (US)

(72) Inventors: José Francisco SILVA ZAVALZA, Aquascalientes (MX); Ricardo VAZQUEZ ROBLES, Aquascalientes (MX); Roberto Carlos FLORES MARMOLEJO, Aquascalientes (MX)

(21) Appl. No.: 18/757,180

(22) Filed: Jun. 27, 2024

(51) Int. Cl. B62D 3/12

(52) U.S. Cl. CPC B62D 3/123

(57) ABSTRACT

A vehicle steering rack assembly includes a tube section and an anti-rattle device. The tube section includes a rack and pinion steering gear assembly and a main rod that extends through the tube section. The main rod moves in a longitudinal direction within the tube section in response to rotation of a pinion gear of the rack and pinion steering gear assembly. The anti-rattle device is attached to the tube section and has at least a first pad that extends into the tube section and is biased to move into contact with the main rod to reduce radial motion (vibrations or rattles) of the main rod.

### BACKGROUND

### Technical Field

The present disclosure generally relates to vehicle steering rack assembly that includes an anti-rattle device. More specifically, the present disclosure relates to vehicle steering rack assembly with an anti-rattle device that dampens vibrations that can occur along the length of a central or main rod within the steering rack assembly.

### Background Information

Most vehicles include a vehicle steering rack assembly operated by turning a steering wheel within the vehicle. There are some vehicle steering rack assembly designs in which rattles or vibrations can occur and be felt by a vehicle operator.

### SUMMARY

It has been discovered that by adding an anti-rattle device to a vehicle steering rack assembly vibrations that sometimes occur within the vehicle steering rack assembly can be reduced or eliminated.

In view of the state of the known technology, one aspect of the present disclosure is to provide a vehicle steering rack assembly with a tube section and an anti-rattle device. The tube section includes a rack and pinion steering gear assembly and a main rod that extends through the tube section. The main rod moves in a longitudinal direction within the tube section in response to rotation of a pinion gear of the rack and pinion steering gear assembly. The anti-rattle device is attached to the tube section and has at least a first pad that extends into the tube section and is biased to move into contact with the main rod to reduce radial motion (vibrations or rattles) of the main rod.

### BRIEF DESCRIPTION OF THE DRAWINGS

Referring now to the attached drawings which form a part of this original disclosure:

FIG. 1 is a side view of a vehicle that includes a vehicle steering rack assembly with an anti-rattle device in accordance with an exemplary embodiment;

FIG. 2 is a rear view of the vehicle steering rack assembly and the anti-rattle device removed from the vehicle in accordance with the exemplary embodiment;

FIG. 3 is a perspective view of the vehicle steering rack assembly and the anti-rattle device removed from the vehicle in accordance with the exemplary embodiment;

FIG. 4 is a perspective view of a section of the vehicle steering rack assembly showing a housing of the anti-rattle device in accordance with the exemplary embodiment;

FIG. 5 is another perspective view similar to FIG. 4 with portions of the housing of the anti-rattle device in phantom revealing internal elements of the anti-rattle device in accordance with the exemplary embodiment;

FIG. 6 is an exploded view showing the various elements of the anti-rattle device in accordance with the exemplary embodiment; and

FIG. 7 is a cross-sectional view of the anti-rattle device taken along the line 7-7 in FIG. 2 showing the various elements of the anti-rattle device in accordance with the exemplary embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

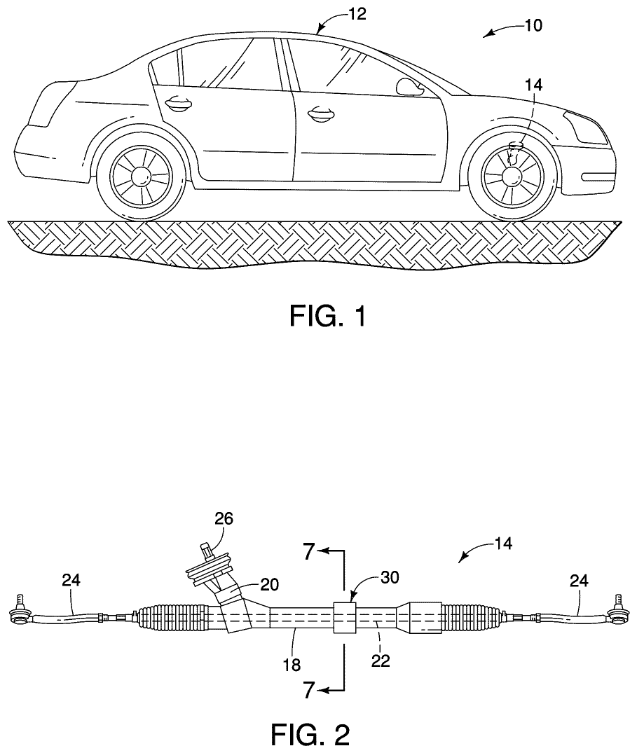

Referring initially to FIG. 1, a vehicle 10 with a vehicle body structure 12 includes a vehicle steering rack assembly 14 is illustrated in accordance with a first embodiment.

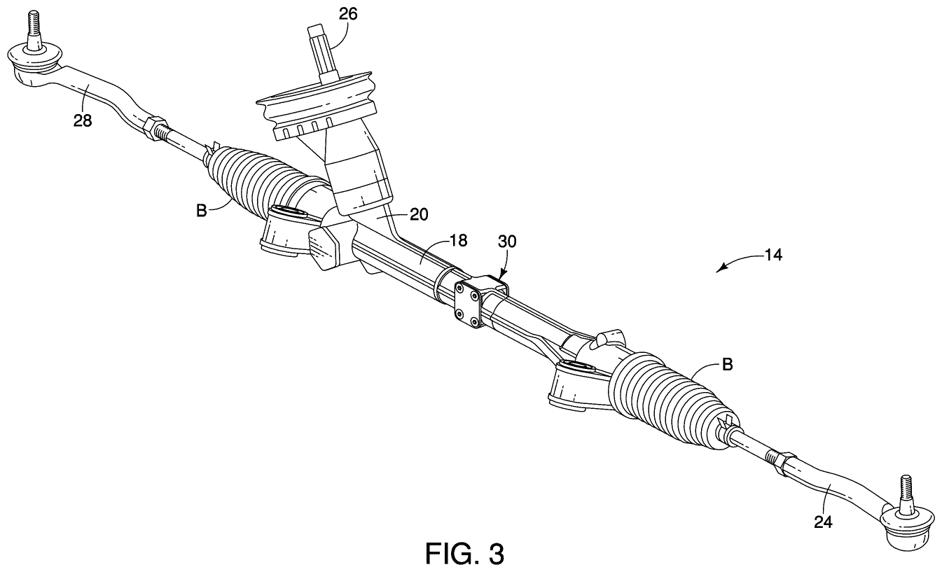

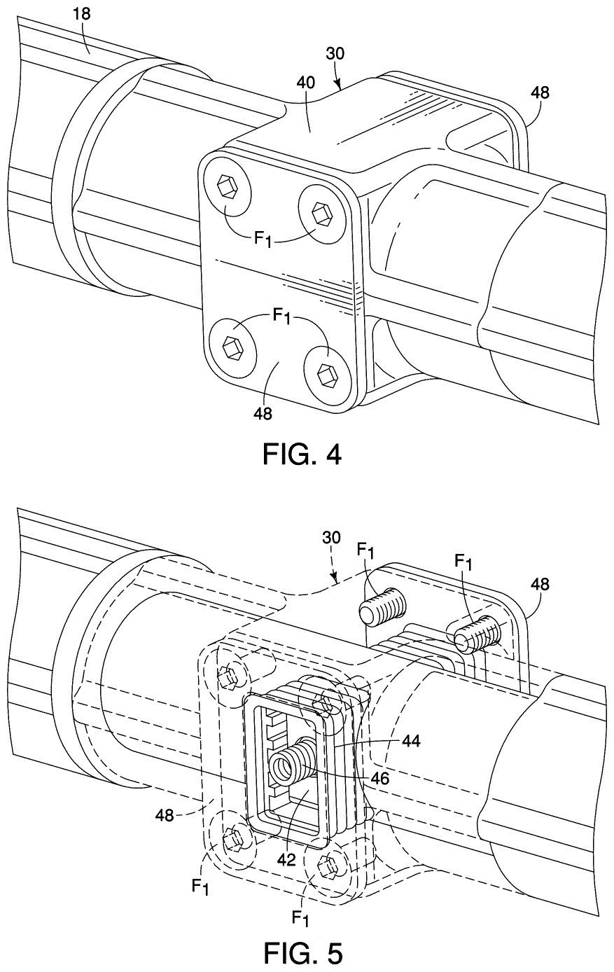

The vehicle steering rack assembly 14 (hereinafter the steering rack 14) is shown removed from the vehicle 10 in FIGS. 2 and 3. The steering rack 14 includes a central hollow tube section 18, a rack and pinion steering gear section 20 (also referred to as a rack and pinion steering gear assembly 20) a main rod 22 that extends through the hollow tube section 18 and connecting rods 24 that are attached to opposite ends of the main rod 22 in a conventional manner. Since the rack and pinion steering gear section 20 and the connecting rods 24 are conventional mechanical features of a steering rack, further description is omitted for the sake of brevity.

The vehicle steering rack assembly 14 also includes an anti-rattle device 30.

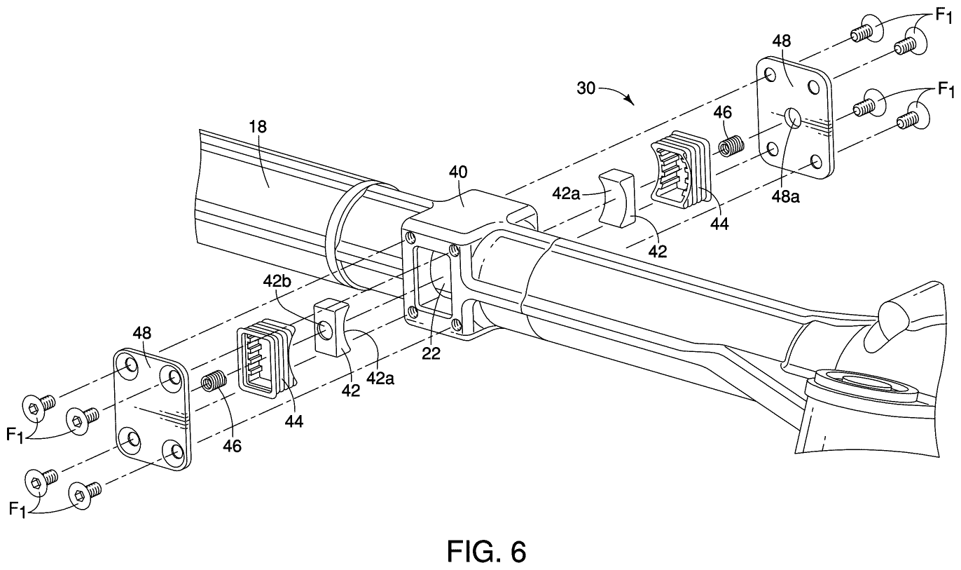

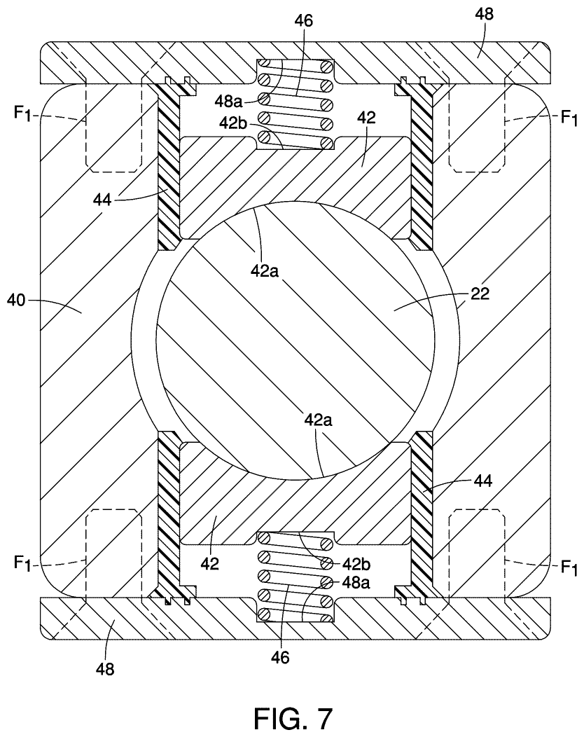

The rod 22 (FIGS. 6, 7 and 8) extends through the hollow tube section 18 and through the anti-rattle device 30. The vehicle steering rack assembly 14 includes a rack pinion gear (not shown). The pinion gear (not shown) is attached to a steering shaft 26 of the rack and pinion steering gear section 20. The steering shaft 26 is configured to attach to a steering shaft (not shown) that is connected to a steering wheel (not shown) of the vehicle 10.

The main rod 22 includes a steering rack section (linearly oriented gears) that engage the pinion gear within the rack and pinion steering gear section 20. The main rod 22 extends the hollow tube section 18 and is moved in a longitudinal direction (relative to the length of the tube 18) within the tube section 18 in response to rotation of the steering shaft 26 (and pinion gear of the rack and pinion steering gear assembly 20).

Since pinion gears, steering racks, steering shafts of steering columns and steering wheels are conventional vehicle elements, further description is omitted for the sake of brevity.

The anti-rattle device 30 includes a housing 40 that is attached to the tube section 18. The housing 40 can also be formed with the tube section 18 such that the housing 40 and the tube section are integrally formed as a single monolithic element, as shown in the drawings. The anti-rattle device 30 includes: a pair of pads 42 (a first pad and a second pad), a pair of retainers 44, springs 46 and covers 48.

The pads 42 each include a curved surface 42a and a circular recess 42b opposite the curved surface 42a. The curved surface 42a on each of the pads 42 is shaped to correspond to the overall shape and diameter of the main rod 22. Since the main rod 22 is preferably cylindrically shaped, the curved surface 42a is a semi-cylindrical concaved surface that mates with the outer cylindrically shaped surface of the main rod 22. Hence, the curved surfaces 42a of the pads 42 face one another.

Each circular recess 42b is centered on a surface of the pad 42 opposite the curved surface 42a. Each of the circular recesses 42b on the pads 42 is dimensioned to receive and limit lateral movement of one end of a corresponding one of the springs 46.

Each of the retainers 44 is rectangular shaped with a rectangular shaped opening extending there through. The outer surface of each of the retainers 44 is dimensioned to fit into a bore or hollow interior of the housing 40. Preferably, the outer surface of each of the retainers 44 is dimensioned to snuggly fit into the hollow interior of the housing 40. Preferably, the retainers 44 are dimensioned such that they need only be pressed into the housing 40 by hand and are not necessarily dimensioned to be press fitted into the housing 40. More preferably, the retainers 44 are dimensioned such that once inserted into the housing 40, the retainers 44 are fixed in position and do not move relative to the main rod 22 when the vehicle 10 is being driven and the steering rack assembly 14 operated to steer the vehicle 10. The retainers 44 are installed to the housing 40 such that they are located on opposite sides of the main rod 22.

Once the retainers 44 are inserted (installed) into the housing 40, the pads 42 are inserted into corresponding ones of the retainers 44 on opposite sides of the main rod 22. The hollow interior of the retainers 44 is dimensioned and shaped to receive corresponding ones of the pads 42 such that the pads 42 can slide within the hollow interior in directions normal or perpendicular to the main rod 22. The retainers 44 are further provided to limit movement of the pads 42 relative to the tube section 18 and the housing 40. The pads 42 are oriented such that the curved surfaces 42a contact opposite sides of the outer surface of the main rod 22. Further, at least a portion of each of the pads 42 extend into the hollow interior of the tube section 18 in order to contact the main rod 22. As well, the pads 42 are biased by the springs 46 into contact with the main rod 22.

The housing 40 (also referred to as the housing part 40) has a first side and a second side opposite the first side. Both ends or sides of the housing 40 have open ends (a first opening and a second opening) that are open to the hollow interior of the housing 40. The cover plates 48 (also referred to as covers 48) are dimensioned to cover the first and second openings of the housing 40. More specifically, the cover plates 48 are held in place to the housing 40 via fasteners F₁ installed to corresponding threaded openings in the housing 40.

Each of the cover plates 48 includes a recess 48a that receives a second end of the spring 46 and limits lateral movement of the spring 46 relative to the cover plate 48. Each of the cover plates 48 can be removed from the first and second sides of the housing 40 by removing the fasteners F₁. The cover plates 48 cover the first and second openings and retain the anti-rattle device 30 (the pads 42, the retainers 44 and the springs 46) within the housing 40.

The springs 46 can be any of a variety of biasing members. However, in the depicted embodiment each of the springs 46 is a coil spring dimensioned to bias corresponding ones of the pads 42 into contact with the main rod 22. Each of the springs 46 is confined at one end by the cover plates 48. The other end of each of the springs 46 presses against a corresponding one of the pads 42.

Hence, the pads 42 are urged into contact with the cylindrical outer surface of the main rod 22 by the springs 46. The force of the springs 46 move each of the pads 42 into contact with the main rod 22 with sufficient for to reduce radial motion of the main rod 22 (movement normal to the lengthwise direction of the main rod 22). The pads 42 are preferably made of a low friction material, such as, PTFE (polytetrafluoroethylene). PTFE has low friction characteristics that allow the main rod 22 to move in its lengthwise direction within the hollow tube section 18 when a vehicle operator is steering the vehicle 10. The biasing force of the springs 46 is sufficient to dampen, reduce and more likely any vibrational movement of the main rod 22 during operation of the vehicle 10.

The location of the anti-rattle device 30 along the main rod 22 and the hollow tube section 18 is determined based upon a vibration analysis. Specifically, when an elongated element experience forces that cause it to vibrate, the elongated element has vibration nodes.

As is well known in physics and music, a node is a point along a standing wave where the wave has minimum amplitude. For instance, in a vibrating guitar string, the ends of the string are nodes where there are effectively no vibrations. There are also nodes at various locations along the string such that by gently touching the string at one of these nodes, the vibration is divided into two or more identical vibration frequencies (harmonics) resembling sinusoidal a wave. The opposite of a node is an anti-node, a point where the amplitude of the standing wave is at maximum. These occur midway between the nodes. In the steering rack assembly 14, the anti-rattle device 30 is positioned at or near an anti-node of the main rod 22. By contacting the main rod 22 at an anti-node where the greatest vibration can occur, the contact essentially dampens, reduces and/or causes all vibration to cease along the length of the main rod 22.

The structure of the vehicle 10 that supports the anti-rattle device 50, including steering and suspension component are conventional components that are well known in the art. Since these structures are well known in the art, these structures will not be discussed or illustrated in detail herein. Rather, it will be apparent to those skilled in the art from this disclosure that the components can be any type of structure and/or programming that can be used to carry out the present invention.

In understanding the scope of the present invention, the term “comprising” and its derivatives, as used herein, are intended to be open ended terms that specify the presence of the stated features, elements, components and/or steps, but do not exclude the presence of other unstated features, elements, components and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the anti-rattle device. Accordingly, these terms, as utilized to describe the present invention should be interpreted relative to a vehicle equipped with the anti-rattle device.

The term “configured” as used herein to describe a component, section or part of a device includes structure that is constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle steering rack assembly, comprising:
a tube section that includes a rack and pinion steering gear assembly and a main rod that extends through the tube section and moves in a longitudinal direction within the tube section in response to rotation of a pinion gear of the rack and pinion steering gear assembly;
an anti-rattle device attached to the tube section having at least a first pad that extends into the tube section and is biased to move into contact with the main rod to reduce radial motion of the main rod.

2. The vehicle steering rack assembly in accordance with claim 1, wherein
the anti-rattle device includes a first retainer that is fixedly attached to the tube section, the first retainer retaining the first pad therein, the first retainer being dimensioned and shaped to restrict movement of the first pad to movement normal to an outer cylindrically shaped surface of the main rod.

3. The vehicle steering rack assembly in accordance with claim 1, wherein
the anti-rattle device includes the first pad and a second pad located on opposite sides of the main rod, both first and second pads being biased into contact with the main rod.

4. The vehicle steering rack assembly in accordance with claim 3, wherein
the first pad and the second pad are biased into contact with the main rod by a coil spring.

5. The vehicle steering rack assembly in accordance with claim 3, wherein
the anti-rattle device includes a first retainer and a second retainer that are attached to the tube section, the first retainer retaining the first pad therein, the first retainer being dimensioned and shaped to limit movement of the first pad to movement normal to an outer cylindrically shaped surface the main rod, and
the second retainer retaining the second pad therein, the second retainer being dimensioned and shaped to limit movement of the second pad to movement normal to the outer cylindrically shaped outer surface of main rod.

6. The vehicle steering rack assembly in accordance with claim 5, wherein
the first retainer has a bore extending therethrough with the first pad being disposed within the bore, and
the second retainer has a bore extending therethrough with the second pad being disposed within the bore.

7. The vehicle steering rack assembly in accordance with claim 1, wherein
the tube section is a hollow structure that includes a main part and a housing part, the housing part being dimensioned to retain the anti-rattle device, the main rod extending through both the main part and the housing part.

8. The vehicle steering rack assembly in accordance with claim 7, wherein
the housing part has a first side and a second side opposite the first side, the first side having a first opening and the second side having a second opening, with respective cover plates that are removably attached to the first and second sides covering the first and second openings thereby retaining the anti-rattle device within the housing part.

9. The vehicle steering rack assembly in accordance with claim 7, wherein
the anti-rattle device includes the first pad and a second pad located on opposite sides of the main rod within the housing part of the tube section, both first and second pads being biased into contact with the main rod.

10. The vehicle steering rack assembly in accordance with claim 9, wherein
the first pad and the second pad are biased into contact with the main rod by a coil spring.

11. The vehicle steering rack assembly in accordance with claim 9, wherein
the anti-rattle device includes a first retainer and a second retainer that are attached to the tube section, the first retainer retaining the first pad therein, the first retainer being dimensioned and shaped to limit movement of the first pad to movement normal to an outer cylindrically shaped surface the main rod, and
the second retainer retaining the second pad therein, the second retainer being dimensioned and shaped to limit movement of the second pad to movement normal to the outer cylindrically shaped outer surface of main rod.

12. The vehicle steering rack assembly in accordance with claim 9, wherein
the first pad includes and low friction material.
